(19) United States
(12) Patent Application Publication
(10) Pub. No.: US 2003/0065970 A1
(43) Pub. Date: Apr. 3, 2003

(54) System and method for creating fault tolerant applications

(76) Inventor: Akshay R. Kadam, Los Angeles, CA (US)

Correspondence Address: Pillsbury Winthrop LLP, Intellectual Property Group, Suite 2800, 725 South Figueroa Street, Los Angeles, CA, 90017-5406, US

(21) Appl. No.: 09/967,623

(22) Filed: Sep. 28, 2001

(51) Int. Cl. G06F 11/00

(52) U.S. Cl. 714/3

(57) ABSTRACT

A system and method for providing fault tolerant applications that are independent of the underlying operating system and hardware system and without the need for application-specific customization. The work units of an application to be made fault tolerant are registered, procedures of the application are defined by a sequence of work units to be executed, and input events and responses are defined. An active FT engine and a standby FT engine are provided to control execution of an active copy of the application and execution of the standby copy of the application, respectively. The FT engines allows the active copy and the standby copy of the application to be synchronized with respect to their internal state information in a lock-step execution of the work units in sequence.

### BACKGROUND OF THE INVENTION

1. Field of the Invention The present invention generally relates to fault tolerant systems. More specifically, the present invention relates to a system, method and storage medium embodying computer-readable code for providing fault tolerant applications that are independent of the underlying operating system and/or hardware system and do not need application-specific customization.

2. Discussion of the Related Art

As computer systems, network systems and software systems become more complex and capital intensive, system failures become more and more unacceptable. This is true even if the system failures are minor. Generally, when systems fail, data is lost, applications become inaccessible, and computer downtime increases. Reducing system failures is often a major goal for companies that wish to provide quality performance and product reliability in the computer systems, network systems and/or software systems which they operate. As such, these systems must be highly dependable; fault tolerance has been implemented as a way of achieving dependability.

For a system to be fault tolerant, it must be able to detect, diagnose, confine, mask, compensate, and/or recover from faults. In general, there are three levels at which fault tolerance may be applied: hardware level, software level and system level. In the hardware level, fault tolerance is often achieved by managing extra hardware resources, through redundant communications, additional memory, duplicate processors, redundant power supply, etc. In the software level, computer software is structured to compensate for faults resulting from changes in data structures or applications because of transient errors, design inaccuracies, or outside attacks. In the system level, system fault tolerance provides functions that compensate for failures that are generally not computer-based. For example, application-specific software may detect and compensate for failures in sensors, actuators, or transducers.

Even in the hardware level and the system level, application software is generally utilized to control, provide and/or assist in the detection and recovering of fault. As such, it is essential that application software be fault tolerant to achieve system fault tolerance because a system containing software cannot be fault tolerant unless the software itself is fault tolerant in one form or another. In fact, nowadays, hardware is generally a couple of orders of magnitude more reliable than software, and the majority of the failures in today's systems that incorporate software applications are caused by software problem(s). Typically, fault tolerance is achieved in application software by either the underlying operating system and hardware or by customizing the application to operate in an active/standby redundant configuration. However, when an application uses the underlying operating system and hardware to achieve fault tolerance, it becomes dependent upon, or “tied down” to, that operating system and hardware platform. Therefore, there is a need for a system that allows an application to be written with portability in mind, so that it may be re-compiled and deployed on any type of operating system and/or hardware platform with little or no modification.

On the other hand, customizing an application that has not been designed to operate in a fault tolerant environment is a complicated task. Application-specific customization of an application, especially one that is large and complicated, is a costly process and requires a large development cycle. For example, expertise of the people who initially created the application is needed. The expertise of the people experienced in the area of fault tolerance is also required. Moreover, applications that were constructed without keeping fault tolerance in mind may require significant re-writing to customize them to be fault tolerant. Therefore, there is a need for a new system and method of providing fault tolerant applications that are not only independent of the underlying operating and/or hardware systems, but may also be implemented without the need for application-specific customization.

### BRIEF DESCRIPTION OF THE DRAWINGS

The accompanying drawings, which are incorporated in and form a part of this specification, illustrate embodiments of the present invention and, together with the description, serve to explain the principles of the present invention:

FIG. 1 shows an exemplary computing system in which embodiments of the present invention may function;

FIG. 2 illustrates a software application according to an embodiment of the present invention;

FIG. 3 shows an illustrative example of a fault tolerant system according to an embodiment of the present invention;

FIG. 4 illustrates lock-step execution performed by a fault tolerant system according to an embodiment of the present invention; and

FIG. 5 illustrates a sample processing system capable of being operated as a system for providing portable fault tolerant applications according to an embodiment of the present invention.

### DETAILED DESCRIPTION

Reference will now be made to the preferred embodiments of the invention, examples of which are illustrated in the accompanying drawings. While the present invention will be described in conjunction with the preferred embodiments, it will be understood that they are not intended to limit the invention to these embodiments. On the contrary, the present invention is intended to cover alternatives, modifications and equivalents, which may be included within the spirit and scope of the invention as defined by the appended claims. Moreover, in the following detailed description of the present invention, numerous specific details are set forth in order to provide a thorough understanding of the present invention. However, the present invention may be practiced without these specific details. In other instances, well-known methods, procedures, components and circuits have not been described in detail as not to unnecessarily obscure aspects of the present invention.

Embodiments of the present invention are directed to a system, method and storage media embodying computer-readable codes for providing portable fault tolerant applications, in which software fault tolerance is achieved without application-specific customization and achieved independently of the underlying operating system and/or hardware system. In one embodiment, a software application to be made fault tolerant is created to operate in an active/standby redundant pair configuration. The software architecture and method for achieving fault tolerance is implemented by a fault tolerance engine(s). In one implementation, the fault tolerance engine is embodied in a set of helper functions to be used by the application to achieve software fault tolerance. In another implementation, the fault tolerance engine takes the form of a library that is linked to the application. The fault tolerance engine resides along with the application, intercepting inputs to the application and controlling execution of the application, while synchronizing with the engine's standby counterpart. Using this design approach, any type of application in any type of operating environment may be written to operate in a fault tolerant environment with little or no modification.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” or “according to an embodiment” appearing in various places throughout the specification are not necessarily all referring to the same embodiment.

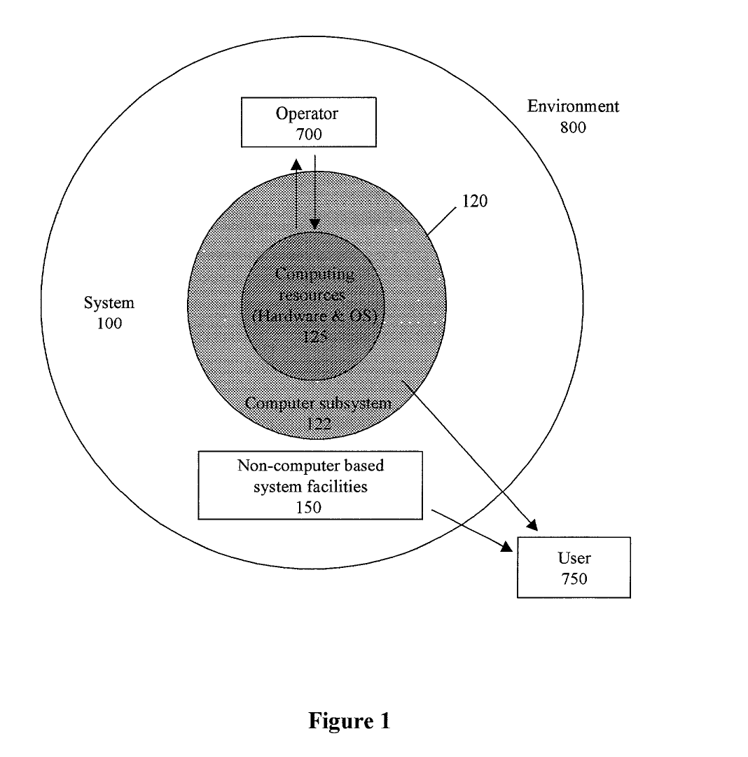

FIG. 1 shows a general system in which embodiments of the present invention may operate. The general system 100 is, for example, shown to operate in an environment 800, and has at least one operator and/or at least one user. In some instances, the operator and the user may be the same person. The general system 100 interacts with the operator 700 and the user 750, providing, for example, feedback to the operator 700 and services to the user 750. The general system 100 includes the entire set of components, both computer-related component 120 and non-computer related component 150, that provides a service to a user. In other embodiments, the general system may only include computer-related component 120. The computer-related component 120 is comprised of computing resources 125 and computer subsystem 122. The computing resources 125 include computer hardware and the operating system (OS). The computer subsystem 122 includes computer subsystems running software, such as applications or programs that operate on top of the OS. Embodiments of the present invention may be implemented in hardware or software, or a combination of both. The embodiments may function in any operating environment provided by the computing resources 125 in which the computer subsystem 122, such as computer programs/applications, may operate. The computer software in the computer subsystem 122 is structured to compensate for faults, such as changes in programs or data structures due to transients or design errors, without depending on the underlying computer resources 125 and without performing application-specific customization on the computer software. Being independent of the underlying computer resources 125 means that the present invention is not dependent upon, or “tied down” to, a particular computer resources 125, providing “portable” fault tolerant applications that may be re-complied and deployed on any type of computer resources with ease. By disposing the need to perform application specific customization, time and resources no longer need to be devoted to perform a complicated task that requires a large development cycle.

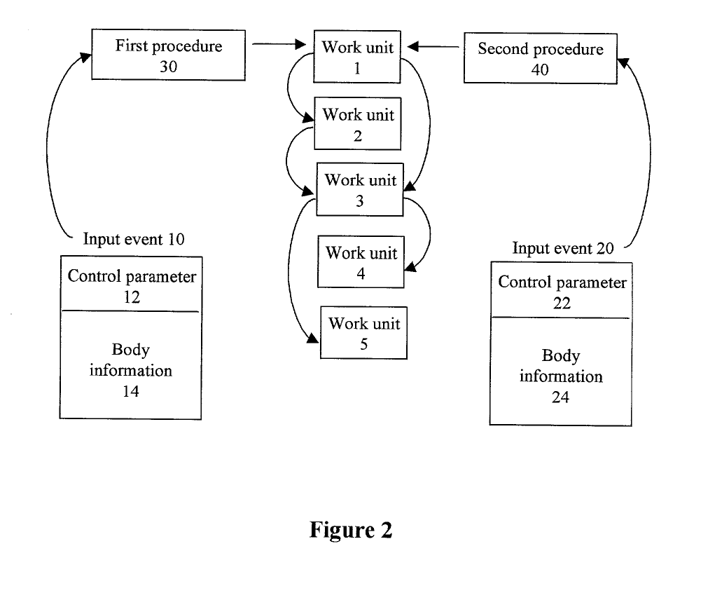

In one embodiment, an application to be made fault tolerant is designed as a collection of “work units,” which may be indivisible atomic units. FIG. 2 illustrates an exemplary software application that is to be made fault tolerant according to an embodiment of the present invention. The operational scheme of the exemplary software application in FIG. 2 includes receiving a first set of input events 10 and a second set of input events 20, triggering a first procedure 30 and a second procedure 40, respectively, and invoking any one of work units 1-5 in a prescribed sequence. The input events to the application may, for example, be any event received from the environment outside of the application, which includes timer ticks, interrupts, user inputs and signals from the hardware. The input events may also be messages from other applications in the system or outside the system. In one implementation, input events 10, 20 are further divided into control parameter parts 12, 22 and body information parts 14, 24. The control parameter part of an input event comprises information in the input event that is used to determine the gist of the input event. For example, one may use the control parameters to determine the identity of the input event, the source location of the input event and the actions to be performed on, or because of, the input event. The body information part may contain other ancillary and supporting information in the input event. Generally, the body information part is much larger than the control parameter part in terms of size because the body information is data-ridden.

The input events received by the application trigger one or more procedures, which in turn trigger the procedures' corresponding sequence of work units. The work units may, for example, be coded in a high level language as invokeable functions. In other embodiments, the work units may also be coded in other type of programming language. As shown in FIG. 2, multiple work units are sequenced and grouped together to form procedures that are implemented by the software application. For example, in response to the first set of input events 10, the application invoke the first procedure 30, which in turn triggers work unit 1, work unit 2, work unit 3, and work unit 5 in sequence. On the other hand, when the application receives the second set of input events 10, the application invoke the second procedure 40, which in turn triggers work unit 1, work unit 3 and work unit 4 in sequence.

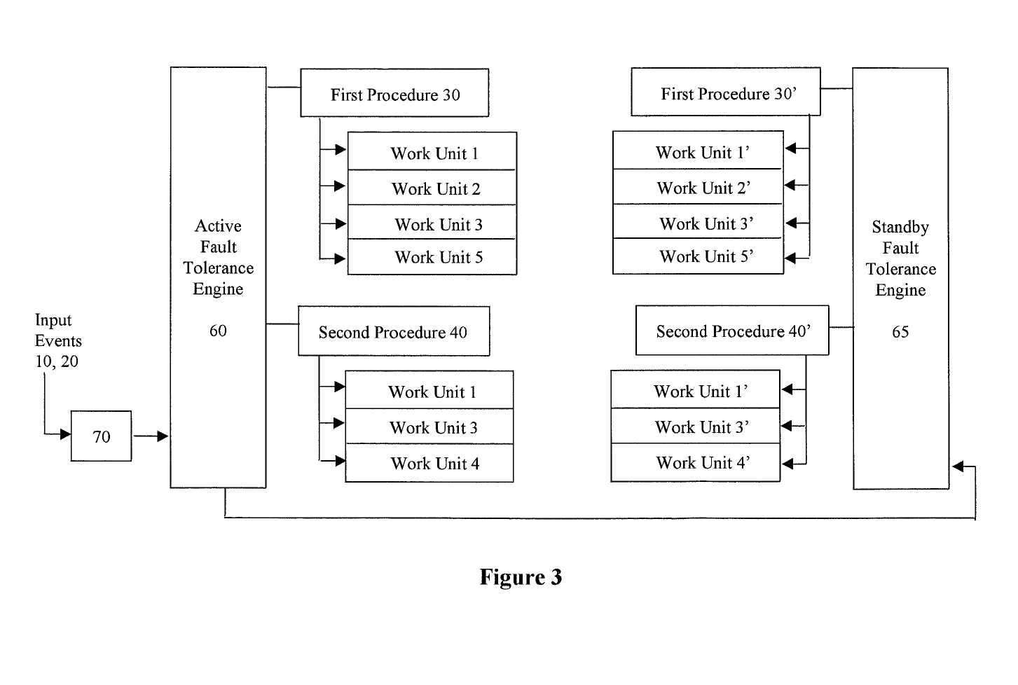

FIG. 3 shows an illustrative example of a fault tolerant system according to an embodiment of the present invention. The fault tolerant system comprises an active fault tolerance (FT) engine 60, a standby FT engine 65, and an application in active/standby redundant pair configuration. The application implements a number of procedures in response to input events that it receives, where each of the procedure is formed by sequencing and grouping a number of work units together. In some instance, a procedure may consist of only one work unit. For simplicity, only two procedures are shown in FIG. 3, a first procedure 30 and a second procedure 40. The two procedures 30, 40 are started on the active FT engine side. When invoked, the first procedure 30 triggers its corresponding work units 1, 2, 3, 5 in sequence, while the second procedure 40 triggers its corresponding work units 1, 3, 4 in sequence. In order to make the application fault tolerant, a second copy of the application is started on the standby FT engine side to form a redundant pair. As shown in FIG. 3, the second copy of the application comprises a first procedure 30′ and a second procedure 40′, where work units 1′, 2′, 3′, 5′ are 5 triggered in sequence when the first procedure 30′ is invoked and work units 1′, 3′, 4′ are triggered in sequence when the second procedure 40′ is invoked. In this configuration, the active and standby FT engines 60, 65 are able to synchronize with one another in a lock-step fashion to achieve hot standby fault tolerance. Although the symbol prime (′) is used to indicate the procedures and work units at the standby side, it is noted that the procedures and work units on the active side are the same as the procedures and work units on the standby side. However, in some embodiments, different programming codes may be used to implement procedures and work units on the active side and their counterparts on the standby side.

To make fault tolerance possible, the application must be initialized upon startup. During startup, the initialization code of the application performs registration steps, which includes registering the work units of the application, defining procedures of the application and defining inputs and input responses for the procedures of the application. These registration steps are performed by invoking services/functions provided by the active FT engine 60. In one embodiment, the active FT engine 60 takes the form of a library or a set of helper functions that is linked into the application. The body of the active FT engine 60 is completely independent of the underlying platform/operating system, and the link may be made statically or dynamically into the application depending on the platform and the compiler used to convert the platform-independent FT engine into a platform dependent library or functions. According to one embodiment of the present invention, the active FT engine 60 controls execution of the application, providing a set of application program interface (API) or function calls that allow registration to be performed on the application, events to be delivered to the application, and lock-step synchronization to be accomplished between the active and standby FT engines 60, 65.

In the first registration step, work units of the application are registered with the active FT engine 60 by invoking services/functions thereof In this example, work units 1-5 are registered with the active FT engine 60. In one implementation, the active FT engine 60 records the location of each work unit, so that previously recorded locations of work units may be utilized when work units specified in a procedure need to be invoked. In the second registration step, procedures of the application are defined, where work units of the procedure are added to a procedure in the sequence that they are to be executed. The defining and adding work units to a procedure is achieved by invoking services/functions of the active FT engine 60. In the third registration step, inputs and input responses for the application are defined. The inputs are defined as events that enter the application from the external environment for processing. The input responses are defined by associating each input event to one or more procedures that will be executed in the sequence they were registered with the FT engine upon receipt of the input event. For each input event, some characteristics of the input event are also defined. The characteristics of the input event are referred to as “control parameters.” The format or content of the control parameters is not important, but they should be sufficient to communicate the gist of the input event to the standby FT engine 65 and/or the standby copy of the application. In one embodiment, the control parameters may be defined as the entire input message instead of a subset of the message. Moreover, other characteristic/parameters may be defined in the registration process, such as input event priorities. In this manner, information such as the location of the work units, the sequence of work units in a procedure and a list of input values that trigger this procedure is obtained by the active FT engine 60 through initialization functions called by the application during start up. Although the word “step” is used above to describe the registration process, it is not necessary that the work units are registered first, the procedures defined second and the inputs defined third. The sequence of registration may be arbitrary.

On completion of the registration steps for the active FT engine 60, a second copy of the application has to be started to form a redundant pair on the standby side. The second copy of the application is initialized in conjunction with the standby FT engine 65 in a similar manner as described above for the application on the active side. A redundant application that includes procedures 30′, 40′ is formed, where invoking the first procedure 30′ triggers work units 1′, 2′, 3′ and 5′ and invoking the second procedure 40′ triggers work units 1′, 3′ and 4′. One copy of the application is designated to be active by informing the FT engine of the relevant copy, which in this case is the active FT engine 60. The other copy of the application is informed that it is to execute in standby mode. In one embodiment, copies of the application are informed in active or standby mode via the API provided by the respective FT engine to the outside world.

After both copies of the redundant applications are initialized in conjunction with their respective FT engines 60, 65, the fault tolerance system is ready to accept and process input events. The FT engine waits for input events to arrive from its environment. In one embodiment, all input events are sent only to the active FT engine 60, and thus the active copy of the application. Routing events to the active copy is performed by a routing agent 70, which resides between the elements of the fault tolerance system that are generating the input events to the application and the application-FT engine itself. The routing agent 70 receives all inputs to the application first and redirects them only to the active FT engine 60. In another embodiment, the routing agent 70 duplicates input events and issue them to both active and standby FT engines 60, 65. In yet another embodiment, instead of providing a routing agent 70, all input events are duplicated and issued to both active FT engine 60 and standby FT engine 65. In such case, the standby copy simply ignores all input events. On the other hand, input events delivered to the active FT engine 60 cause it to schedule the corresponding procedure(s) for execution by invoking each of the work units of the procedure in the sequence that they have been specified. For example, in the exemplary fault tolerance system shown in FIG. 3, receiving input events 10, 20 causes procedures 30, 40 and their corresponding work units to be executed on the active FT engine side. In addition, redundant procedures 30′, 40′ and their corresponding work units are also executed in a synchronized fashion on the standby FT engine side, the manner of synchronization being described in more detail below: This enables the application to accept and process input events in a controlled manner via the FT engines.

In particular, on receiving an input event, such as the input event 10, the active FT engine 60 makes a copy of the control parameters 12 of the input event 10 and sends the control parameters 12 to the standby FT engine 65. Based on the input event 10, the active FT engine 60 looks up its internal information and identifies that procedure 30 needs to be executed to handle or process the received input event 10. In one implementation, the active FT engine 60 searches for the procedure(s) that has been defined for input values occurring within the received input event 10. Similarly, the standby FT engine 65 determine a procedure(s) to execute for handling the input event 10, which are represented by the control parameters 12 received from the active FT engine 60. The procedure corresponding to control parameters 12 is procedure 30′, a redundant pair of the procedure 30. Only control parameters are required at the standby FT engine 65 and the standby side of the application because it is these parameters that are used to determine the procedure, the work units and the sequence of work units to be executed. With the control information, the standby FT engine 65 is able to invoke the same procedure as invoked on the active side.

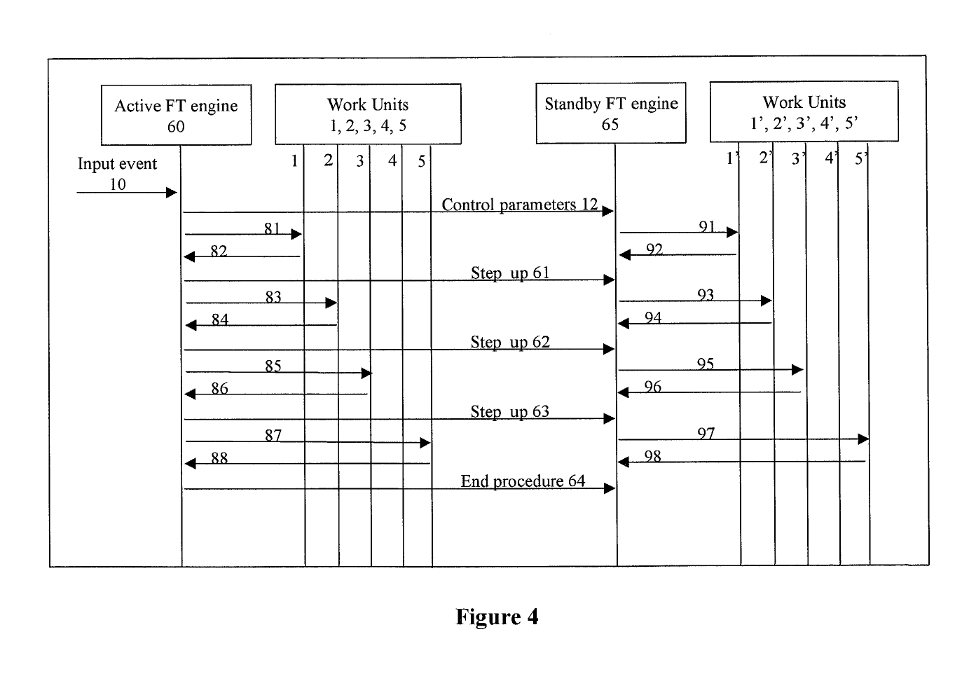

After control parameters are passed to the standby FT engine 65 and once a procedure(s) based on an input event is found at the active FT engine side, the active FT engine 60 and the standby FT engine 65 execute their corresponding work units in lock-step fashion, so that both copies of the application are in synchronization with one another. FIG. 4 illustrates lock-step execution performed by an exemplary fault tolerant system according to an embodiment of the present invention. As shown in the example in FIG. 4, work units 1, 2, 3, 5 and corresponding work units 1′, 2′, 3′ 5′ are carried out in lock step execution with the invocation of procedures 30, 30′ due to the receipt of the input invent 10. The active FT engine 60 starts the procedure by invoking the first work unit of the procedure corresponding to the input event. Herein, input event 10 causes the first work unit 1 of the procedure 30 to be executed at the active FT engine side, as represented by arrow 81 in FIG. 4. The input event 10 also causes the control parameters 12 to be sent to the standby FT engine 65. The control parameters 12 in turn trigger the execution of the first work unit 1′ of the procedure 30′ at the standby FT engine side, as represented by arrow 91. When the execution of the first work unit 1 of the procedure 30 is completed, a signal is sent back to the active FT engine 60 to inform it of the completion. This signal is represented by arrow 82. Similarly, when the execution of the first work unit 1′ of the procedure 30′ is completed, a signal represented by arrow 92 is sent back to the standby FT engine 65 to inform it of the completion.

Completion of the execution of a work unit at the standby FT engine side, however, does not mean that the next work unit at the standby FT engine side will be executed. The standby FT engine 65 would not proceed to execute the next work unit 2′ until a “step up” signal is received form the active FT engine side. This “step up” signal would not be sent from the active FT engine 60 until the active FT engine 60 receives the signal represented by arrow 82, signaling that execution of the first work unit 1 is completed (i.e., there is no fault in carrying out part of the procedure 30 represented by work unit 1). Upon receipt of the signal represented by arrow 82, the active FT engine 60 sends a “step up” signal/message 61 to its standby counterpart, informing the standby FT engine 65 to proceed to the next work unit 2′ of the procedure 30′. Thus, on completing the execution of the first work unit 1′ on the standby side, the standby FT engine 65 does not proceed to execute the next work unit 2′ until a “step up” signal is received. After the active FT engine 60 sends a “step up” signal/message 61 to the standby FT engine side, it proceeds to execute the second work unit 2 in the sequence. This is represented by arrow 83. On the other hand, because of the receipt of the “step up” signal/message 61, the standby FT engine 65 is able to proceed to execute the second work unit 2′ in the series, as represented by arrow 93. When the execution of the second work unit 2′ is completed, this fact is relayed to the standby FT engine 65, as represented by arrow 94. However, the standby FT engine 65 waits for a “step up” signal/message 62 before it proceeds to execute the next work unit 3′ in the series. The “step up” signal/message 62 is sent from the active FT engine 60 upon the completion of the second work unit 2 in the series on the active application side, as represented by arrow 84. This lock-step process between the work units of the active and standby copies of the procedures 30, 30′ is continued until the procedures end. In this case, the third work units 3, 3′ are executed and completed in the lock-step fashion, as represented by the step up signal/message 62, arrows 85, 86 on the active side, and arrows 95, 96 on the standby side. Likewise, the fourth work units 5, 5′ are executed and completed in the lock-step fashion, as represented by the step up signal/message 63, arrows 87, 88 on the active side, and arrows 97, 98 on the standby side. Since work units 5, 5′ are the last work units for the particular procedures, the procedures 30, 30′ end. An “end procedure” signal/message 64 is sent from the active FT engine 60 to the standby FT engine 65, informing the standby FT engine 65 that the procedure 30′ has now been completed.

Oftentimes, an application comprises a number of procedures that need to be carried out. As a result, on completion of the procedure 30, the next procedure for the input event 10 is executed if specified. In the example, the next procedure to be carried out is procedure 40. For simplicity, the execution of procedure 40 is not illustrated in FIG. 4. If there were other procedures that need to be carried out after procedure 40, they would also be completed in a sequential manner. When all of the procedures related to the input event 10 are completed, the input event 10 has been completely processed. Before generating an output as a result of the procedures being carried out, the application invokes a FT engine function to examine if it is allowed to generate an output to the environment. In other words, the application is to request permission to generate outputs from FT engines. If a FT engine allows the application to generate outputs, the application may issue the output to its environment, otherwise the application suppresses generation of the output. In one embodiment, only the active FT engine 60 may allow outputs to be generated from the active copy of the application. For the standby copy of the application, the FT engine 65 does not grant permission to the application to generate outputs. Instead, the FT engine 65 suppresses all outputs from the standby copy of the application, preventing any interaction with its environment while at the same time, allowing the standby copy of the application to be in the same state as the active copy.

Using this technique, all work units of all procedures of a given application are executed in lock-step between the active and standby copies of the application. Since the same work units and procedures are executed on the standby side as those executed on the active side for each and every input received by the application, the standby copy of the application is in the same state as the active copy of the application at any instant of time. With the lock-step execution of the procedures on both the active side and standby side, both copies of the application are in synchronization with one another with respect to their internal state information. This allows the standby copy of the application to take over processing from the active at anytime, even at mid-procedure, if the active copy fails.

Detection of faults in a system is usually handled by an external fault-detector component (not shown). The fault-detector component resides outside the application as a separate component in the system, and the location of such a component is dependent on the system. When a fault occurs and has been detected and isolated by the external fault-detector component, a trigger is provided to the standby FT engine 65, instructing it to continue the failed procedure. In one embodiment, this trigger is delivered by the fault-detector component to the FT engine 65 via the API provided by the FT engine to the outside world. For example, in mid-procedure, the standby FT engine 65 may be waiting for a “step up” signal from the active FT engine 60. However, if the active copy of the application and/or the active FT engine 60 fails, the standby FT engine 65 is stuck at this point waiting for the “step up” signal. The external fault-detector then comes into play, detecting the failure of the active copy of the application and then instructing the stuck standby FT engine 65 to continue in active mode. This signal to the standby FT engine 65 from the external fault detector causes the standby copy of the application to become “un-stuck” and resume operating in active mode as instructed by the fault detector component. The active mode of operation, which allows the standby copy of the application to generate outputs to its external environment, is assumed, and the failed or halted procedure is continued by the standby copy. In one embodiment, the failed active copy of the application is terminated after the standby copy becomes active and takes over execution. The fault detector may, for example, perform the termination.

According to an embodiment of the present invention, the standby copy of the application is provided with mechanisms to recover a partially executed work unit, so that the standby FT engine 65 is able to proceed with a failed procedure. In one implementation, the work unit has the property that invocation of the same work unit multiple times with the same input parameters has the same effect on the internal state of the application and its environment as invoking the work unit one time. This allows the standby FT engine 65 to resume the procedure on the standby side at the failed work unit without any adverse side-effects of invoking the same work unit twice, as it may have executed partially or completely on the active side just before the failure to impart partial or complete internal stage change or environmental interactions.

In another implementation, the work unit has an inverse function defined that allows partial or complete action of the work unit to be undone. This is often desired because halting the procedure in an ad-hoc manner due to faults results in leaving the effects of a half-executed procedure in the system. With this feature, the standby FT engine 65 is able to rollback a failed, partially executed work unit by invoking the inverse function. In a complete procedure rollback, each work unit of the procedure has an inverse function defined, so that the effects of a partially executed procedure may be undone or removed from the system in terms of internal state exchanges in the application and state changes in the environment. In one embodiment, the rollback is initiated and controlled by the FT engine by invoking the inverse operation for each of the procedure's work units executed until the point that the rollback procedure is to be executed. The failed procedure may then be continued by invoking the work unit on the standby side in the forward direction, rolling back the partially executed operation and then restarting it from the beginning. For a given procedure, depending on how the work units are structured, the FT engine takes the recovery action as appropriate to the work unit that was executing when failure was detected. This provides the application with a formal rollback and recovery system in addition to the fault tolerance capability.

According to an embodiment of the present invention, interleaved events are allowed and are completely synchronized on the active and standby copies of the application in a similar fashion as synchronizing the work units. As used herein, the interleaved events are input events that are handled while another event is currently being processed. Typically, interleaved events can cause havoc in a system that is to run in synchronization with another. However, using the lock-step execution architecture, interleaved events may be provided without much trouble. Examples of the interleaved events are timer tick events or interrupts that may need to be processed by the application as they occur, as opposed to being deferred until the current procedure has been executed to completion. The requirement of interleaved event processing is dependent on the system, the application and its environment. For example, one implementation defers timer events until the current procedure has been executed to completion. This may also be achieved by having the FT engine queue input events and execute them in sequence after the current procedure has completed execution.

According to an embodiment of the present invention, fault tolerance is achieved by creating two separate sets of work units, each providing the same functions but created using different coding schemes. In the embodiment, each work unit is implemented by two separate code blocks, e.g., using C programming language functions. Preferably, the two sets of the work units are designed and implemented by two separate design teams. On one hand, all procedures on the active copy of the application use one set of the procedures and their corresponding work units from the first set of the work units. On the other hand, all procedures on the standby copy of the application use the other set of the procedures and their corresponding work units from the second set of the work units. As a result, different code is being executed on the active and standby sides. This not only allows both active and standby copies of the application to run in lock-step as in other embodiments, but it also prevents a bug in one work unit from causing both copies of the application to crash.

In one embodiment, the fault tolerant system with lock-step architecture is used to implement a state update based warm standby system. In one implementation, this is achieved by having the active FT engine completely invoke the procedure to be executed, collect information such as state information updated by the procedure, and send the information to the standby copy of the application. On receiving this state information, which is like another input event on the standby copy, a pre-defined procedure is invoked, which reads the update information and applies the result to the internal state on the standby side. The FT engine may, for example, provide a standard API that allows the application to perform data-centric updates to its standby copy. In essence, the FT engine may provide both the infrastructures to allow the creation of hot standby control-centric applications as well as data-centric warm standby applications. This way, several different procedures may follow different approaches to make themselves fault tolerant. For example, a procedure A that is highly sensitive to failures may use the hot standby control-centric approach, while a procedure B that is more robust and can handle intermediate step failures better than procedure A may use the warm standby approach.

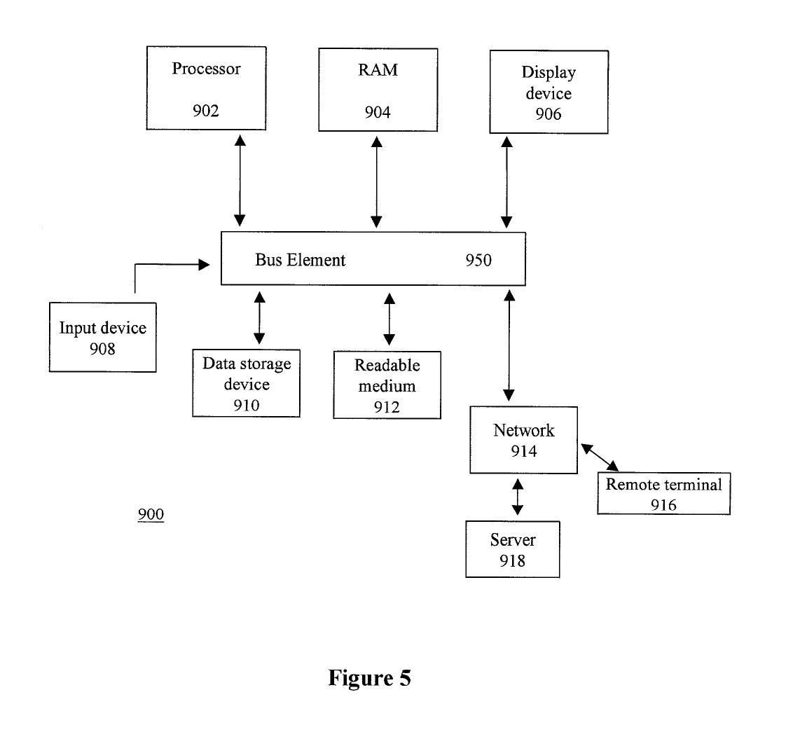

According to an embodiment, the present invention is implemented as a set of helper functions or libraries to be utilized by, or operated in conjunction with, programs/applications that wish to achieve software fault tolerance. The helper functions or libraries will execute on programmable systems comprising at least one processor, a data storage system, at least one input device, and at least one output device. As used herein, the data storage system may include only RAM or memory, and not persistent media like a hard disk. The helper functions or libraries may be implemented in a high level procedural or object programming language to communicate with a processing system. The helper functions or libraries may also be implemented in assembly or machine language, if desired. In fact, the invention is not limited in scope to any particular programming language. In any case, the language may be a compiled or interpreted language. FIG. 5 illustrates a sample processing system capable of being operated, together with the fault tolerance engines, as a system for providing portable fault tolerant applications without system dependence and without application-specific customization according to an embodiment of the present invention.

In FIG. 5, a general-purpose computer system 900 is illustrated. Such a computer system architecture comprises a bus element 950 for communicating information. Various elements are coupled with the bus element 950, including a processor 902, a random access memory (RAM) 904, a display device 906, an alphanumeric and/or other input device 908, a data storage device 910, a readable medium 912 and a network 914. Although elements, such as the display device 906, the input device 908, the data storage device 910 and the readable medium 912 are shown in FIG. 5, it is noted that they are not necessary for creating a fault tolerant system of the present invention. The fault tolerant system may be operated with simply a bus, a RAM or other type of memory and a processor. In one implementation, the processor 902 is utilized for processing audio, video and data information. However, the processor 902 may also be used only for processing data by executing the application program code. The RAM 904 stores information and instructions for the processor 902. The display device 906 displays information to the computer user, while the input device 908 communicates information and command selections to the processor 902. The data storage device 910, such as a magnetic disk and disk drive, stores information and instructions. The readable medium 912, such as a floppy disk or a CD, retrieves information and instructions for the processor 902. The bus element 900 is further coupled to network 914 for accessing resources on the network 914, such as server 918 and remote terminal 916 Although FIG. 5 illustrates a general purpose computer system, the system and method of the present invention may also be programmed or implemented in various types of systems according to other embodiments of the present invention. Modification may also be made to the general-purpose computer system, such as including a second bus element or a second processor.

Embodiments of the present invention are related to the use of the system 900 as a system for providing portable fault tolerant applications with system independence and without application-specific customization. According to one embodiment, such processing may be performed by the system 900 in response to the processor 902 executing sequences of instructions in the memory 904. Such instructions may be read into the memory 904 from another computer-readable medium, such as data storage device 910, or from another source, such as the network 914. Execution of the sequences of instructions stored in the memory 904 causes the processor 902 to execute the providing of portable fault tolerant applications according to the embodiment. In an alternative embodiment, hardware circuitry may be used in place of or in combination with software instructions to implement embodiments of the present invention. Thus, the present invention is not limited to any specific combination of hardware circuitry and software.

Many advantages are intrinsic to the present invention of providing fault tolerant applications that are independent of the underlying OS and hardware system and without the need for application-specific customization. First, because the fault tolerant applications are independent of the OS and hardware, they are not “tied down” to a specific platform. This means that fault tolerant applications are created with portability in mind, so that applications may be written to operate in a fault tolerant environment with little or no modification regardless on which platform they are being deployed. By eliminating the need for customizing an application that has not been designed to operate is a fault tolerant environment, a complicated lengthy task and a costly exercise are eliminated. Moreover, because fault tolerance is achieved by synchronizing the execution of work-units on the active and standby copies of the application, a control-centric approach that uses control information to synchronize the active and standby copies is realized. This differs from the data-centric approach in which data or state change information is updated from the active copy to the standby copy of the application. This yields the advantages of reduced bandwidth requirements between active and standby copies. Each control parameter/message used to synchronize the active copy with its standby copy is smaller than a data filled update message in a data-centric system, especially with applications that require much state modification. This also allows the standby copy of the application to be fully synchronized with the active copy of the application, which may be a hard requirement of certain types of applications, including transaction processing application. For example, some classes of information require that no information be lost during a failure and cannot be made fault tolerant using the data-centric approach. In addition, the code written for data-centric system is specific to each application, while creating the FT engine is a one-time effort in comparison.

While the foregoing description refers to particular embodiments of the present invention, it will be understood that the particular embodiments have been presented for purposes of illustration and description. They are not intended to be exhaustive or to limit the invention to the precise forms disclosed. Many modifications and variations are possible in light of the above teachings and may be made without departing from the spirit thereof For example, the general system 100 in FIG. 1 may comprise multiple computing system arranged in a network environment and serving a number of users. The fault tolerance architecture may also be extended to define a distributed application and form a distributed FT architecture. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for providing a fault tolerant application, the method comprising:
registering work units of an application to be made fault tolerant;
defining at least one procedure of the application by a sequence of work units to be executed;
defining input events and input responses for the application by associating each input event to one or more procedures that execute on receipt of the input event;
receiving an input event at an active FT engine, the active FT engine controlling execution of an active copy of the application in response to the input event and sending control signals to a standby FT engine;
receiving the control signals at the standby FT engine, the standby FT engine controlling the execution of a standby copy of the application based on the control signals from the active FT engine, wherein the active copy and the standby copy of the application are synchronized with respect to their internal state information in a lock-step execution of the work units in sequence.

2. The method of claim 1, wherein the receiving of the input event at the active FT engine triggers the at least one procedure, which in turn trigger the corresponding first sequence of work units of the procedure.

3. The method of claim 2, wherein the control signals received at the standby FT engine include control parameters and step up signals.

4. The method of claim 3, wherein receiving of the input event at the active FT engine causes control parameters to be sent to the standby FT engine, which triggers at least one redundant procedure defined by a corresponding second sequence of work units, and completing execution of a work unit in the first sequence of work units at the active FT engine causes a step up signal to be sent to the standby FT engine, the step up signal allowing the standby FT engine to continue executing work units in the redundant procedure.

5. The method of claim 4, wherein the control parameters are used to determine gist of the input event, including identity of the input event and, optionally, at least one of a source location of the input event and actions to be performed as a result of the input event.

6. The method of claim 1, wherein the input event is an event received from an environment outside of the application.

7. The method of claim 1, further comprising providing a routing agent to route input events to the active FT engine.

8. The method of claim 1, wherein the work units has the property that invocation of the same work unit multiple times with the same input parameters has the same effect on the internal state of the application and its environment as invoking the work unit once.

9. The method of claim 1, wherein the work units has an inverse function defined that allows partial or complete action of the work units to be undone.

10. The method of claim 1, wherein the active copy of the application and the standby copy of the application are implemented by different coding schemes through the use of two separate set of work units.

11. The method of claim 1, further comprising providing data-centric updates to the standby copy of the application.

12. A computer readable medium for use in conjunction with a fault tolerance system for providing fault tolerant applications, the computer readable medium including computer readable instructions encoded thereon for:
registering work units of an application to be made fault tolerant;
defining at least one procedure of the application by a sequence of work units to be executed;
defining input events and input responses for the application by associating each input event to one or more procedures that execute on receipt of the input event;
receiving an input event at an active FT engine, the active FT engine controlling execution of an active copy of the application in response to the input event and sending control signals to a standby FT engine;
receiving the control signals at the standby FT engine, the standby FT engine controlling the execution of a standby copy of the application based on the control signals from the active FT engine, wherein the active copy and the standby copy of the application are synchronized with respect to their internal state information in a lock-step execution of the work units in sequence.

13. The computer readable medium of claim 12, wherein the receiving of the input event at the active FT engine triggers the at least one procedure, which in turn trigger the corresponding first sequence of work units of the procedure.

14. The computer readable medium of claim 13, wherein the control signals received at the standby FT engine include control parameters and step up signals.

15. The computer readable medium of claim 14, wherein receiving of the input event at the active FT engine causes control parameters to be sent to the standby FT engine, which triggers at least one redundant procedure defined by a corresponding second sequence of work units, and completing execution of a work unit in the first sequence of work units at the active FT engine causes a step up signal to be sent to the standby FT engine, the step up signal allowing the standby FT engine to continue executing work units in the redundant procedure.

16. The computer readable medium of claim 15, wherein the control parameters are used to determine gist of the input event, including identity of the input event and, optionally, at least one of a source location of the input event and actions to be performed as a result of the input event.

17. The computer readable medium of claim 12, wherein the input event is an event received from an environment outside of the application.

18. The computer readable medium of claim 12, further comprising computer readable instructions encoded thereon for providing a routing agent to route input events to the active FT engine.

19. The computer readable medium of claim 12, wherein the work units has the property that invocation of the same work unit multiple times with the same input parameters has the same effect on the internal state of the application and its environment as invoking the work unit once.

20. The computer readable medium of claim 12, wherein the work units has an inverse function defined that allows partial or complete action of the work units to be undone.

21. The computer readable medium of claim 12, wherein the active copy of the application and the standby copy of the application are implemented by different coding schemes through the use of two separate set of work units.

22. The computer readable medium of claim 12, further comprising computer readable instructions encoded thereon for providing data-centric updates to the standby copy of the application.

23 A method for providing a fault tolerant system, the method comprising:
providing an active copy of an application to be made fault tolerant;
providing a standby copy of the application;
providing an active fault tolerance (FT) engine, the active FT engine accepting an input event, controlling execution of the active copy of the application in response to the input event, and outputting control signals;
providing a standby FT engine, the standby FT engine accepting the control signals from the active FT engine and controlling the execution of the standby copy of the application based on the control signals from the active FT engine, wherein the active and standby copies of the application includes at least one procedure being defined by a sequence of work units to be executed, the active copy and the standby copy of the application being synchronized with respect to their internal state information in a lock-step execution of the work units in sequence.

24. The method of claim 23, wherein the receiving of the input event at the active FT engine triggers the at least one procedure, which in turn trigger the corresponding first sequence of work units of the procedure.

25. The method of claim 24, wherein the control signals received at the standby FT engine include control parameters and step up signals.

26. The method of claim 25, wherein receiving of the input event at the active FT engine causes control parameters to be sent to the standby FT engine, which triggers at least one redundant procedure defined by a corresponding second sequence of work units, and completing execution of a work unit in the first sequence of work units at the active FT engine causes a step up signal to be sent to the standby FT engine, the step up signal allowing the standby FT engine to continue executing work units in the redundant procedure.

27. The method of claim 26, wherein the control parameters are used to determine gist of the input event, including identity of the input event and, optionally, at least one of a source location of the input event and actions to be performed as a result of the input event.

28. The method of claim 23, wherein the work units has the property that invocation of the same work unit multiple times with the same input parameters has the same effect on the internal state of the application and its environment as invoking the work unit once.

29. The method of claim 23, wherein the work units has an inverse function defined that allows partial or complete action of the work units to be undone.

30. The method of claim 23, wherein the active copy of the application and the standby copy of the application are implemented by different coding schemes through the use of two separate set of work units.

31. The method of claim 23, further comprising providing data-centric updates to the standby copy of the application.

32. A computer readable medium for use in conjunction with a fault tolerance system for providing fault tolerant applications, the computer readable medium including computer readable instructions encoded thereon for:
providing an active copy of an application to be made fault tolerant;
providing a standby copy of the application;
providing an active fault tolerance (FT) engine, the active FT engine accepting an input event, controlling execution of the active copy of the application in response to the input event, and outputting control signals;
providing a standby FT engine, the standby FT engine accepting the control signals from the active FT engine and controlling the execution of the standby copy of the application based on the control signals from the active FT engine, wherein the active and standby copies of the application includes at least one procedure being defined by a sequence of work units to be executed, the active copy and the standby copy of the application being synchronized with respect to their internal state information in a lock-step execution of the work units in sequence.

33. The computer readable medium of claim 32, wherein the receiving of the input event at the active FT engine triggers the at least one procedure, which in turn trigger the corresponding first sequence of work units of the procedure.

34. The computer readable medium of claim 33, wherein the control signals received at the standby FT engine include control parameters and step up signals.

35. The computer readable medium of claim 34, wherein receiving of the input event at the active FT engine causes control parameters to be sent to the standby FT engine, which triggers at least one redundant procedure defined by a corresponding second sequence of work units, and completing execution of a work unit in the first sequence of work units at the active FT engine causes a step up signal to be sent to the standby FT engine, the step up signal allowing the standby FT engine to continue executing work units in the redundant procedure.

36. The computer readable medium of claim 35, wherein the control parameters are used to determine gist of the input event, including identity of the input event and, optionally, at least one of a source location of the input event and actions to be performed as a result of the input event.

37. The computer readable medium of claim 32, wherein the work units has the property that invocation of the same work unit multiple times with the same input parameters has the same effect on the internal state of the application and its environment as invoking the work unit once.

38. The computer readable medium of claim 32, wherein the work units has an inverse function defined that allows partial or complete action of the work units to be undone.

39. The computer readable medium of claim 32, wherein the active copy of the application and the standby copy of the application are implemented by different coding schemes through the use of two separate set of work units.

40. The computer readable medium of claim 32, further comprising computer readable instructions encoded thereon for providing data-centric updates to the standby copy of the application.

41. A fault tolerance system comprising:
an active copy of an application to be made fault tolerant;
a standby copy of the application;
an active fault tolerance (FT) engine, the active FT engine accepting an input event, controlling execution of the active copy of the application in response to the input event, and outputting control signals;
a standby FT engine, the standby FT engine accepting the control signals from the active FT engine and controlling the execution of the standby copy of the application based on the control signals from the active FT engine, wherein the active and standby copies of the application includes at least one procedure being defined by a sequence of work units to be executed, the active copy and the standby copy of the application being synchronized with respect to their internal state information in a lock-step execution of the work units in sequence.

42. The fault tolerance system of claim 41, wherein accepting the input event by the active FT engine triggers the at least one procedure, which in turn trigger a corresponding first sequence of work units of the procedure.

43. The fault tolerance system of claim 42 wherein the control signals received at the standby FT engine include control parameters and step up signals.

44. The fault tolerance system of claim 43, wherein accepting of the input event by the active FT engine causes control parameters to be sent to the standby FT engine, which triggers at least one redundant procedure defined by a corresponding second sequence of work units, and completing execution of a work unit in the first sequence of work units at the active FT engine causes a step up signal to be sent to the standby FT engine, the step up signal allowing the standby FT engine to continue executing work units in the redundant procedure.

45. The fault tolerance system of claim 44, wherein the control parameters are used to determine gist of the input event, including identity of the input event and, optionally, at least one of a source location of the input event and actions to be performed as a result of the input event.

46. The fault tolerance system of claim 45, wherein the work units has the property that invocation of the same work unit multiple times with the same input parameters has the same effect on the internal state of the application and its environment as invoking the work unit once.

47. The fault tolerance system of claim 41, wherein the work units has an inverse function defined that allows partial or complete action of the work units to be undone.

48. The fault tolerance system of claim 41, wherein the active copy of the application and the standby copy of the application are implemented by different coding schemes through the use of two separate set of work units.

49. The fault tolerance system of claim 41, wherein data-centric updates are provided to the standby copy of the application.

50. The fault tolerance system of claim 41, further comprising an external fault-detector component to detect faults in the system, eventually resulting the standby FT engine to continue in active mode.
